(19) United States
(12) Patent Application Publication
(10) Pub. No.: US 2025/0021322 A1
(43) Pub. Date: Jan. 16, 2025

(54) EFFICIENTLY ESTABLISHING USER PROFILES ON MOBILE DEVICES

(71) Applicant: MLABS Industries LLC, Addison, TX (US)

(72) Inventor: Denver Brittain, Fort Worth, TX (US)

(21) Appl. No.: 18/420,061

(22) Filed: Jan. 23, 2024

Related U.S. Application Data
(60) Provisional application No. 63/526,314, filed on Jul. 12, 2023.

(51) Int. Cl. G06F 8/61; G06F 11/22; H04L 67/306

(52) U.S. Cl. CPC G06F 8/64; G06F 11/2289; H04L 67/306

(57) ABSTRACT

A method to establish a user profile on a mobile device includes receiving an input from an operator; generating at least one heuristic list from the input; querying capability information from the mobile device; preparing a deployment sequence from the heuristic list and the capability information; executing the deployment sequence; causing the mobile device to invoke a command from the deployment sequence; preparing a test sequence; causing the mobile device to invoke a test command; and verifying an output of the test command with an expected output.

### CROSS-REFERENCE TO RELATED APPLICATIONS

This application claims the benefit of U.S. Provisional Patent Application No. 63/526,314, filed Jul. 12, 2023 and entitled “AUTOMATED MOBILE DEVICE USER PROFILE INSTANTIATION,” which is hereby incorporated by reference in its entirety.

In cases where the present application conflicts with a document incorporated by reference, the present application controls.

### BACKGROUND

A user profile is a set of applications, data, and permissions associated with an individual user on a computer. A computer may have multiple user profiles. For example, a multi-user server may have a privileged profile for a system administrator and an unprivileged profile for a regular computer user. The privileged profile may include permission to permanently delete any file on the server, may include network management applications, and may include a private data storage. The unprivileged profile does not include permission to permanently delete files nor any network management applications, but it may include a private data storage.

In another example, a single user profile may be on a plurality of mobile devices. For example, a corporation may provide each of a plurality of employees a standard work phone. The standard work phone includes a standard work profile. The standard work profile may include permissions to receive phone calls but not to operate a camera. The standard profile may include work applications, for example, a calendar application.

In another example, a plurality of user profiles may exist on a plurality of devices. For example, a work laptop issued by an employer may have a work profile and a personal profile. The employer issues a plurality of laptops to its plurality of employees. The work profiles on the plurality of laptops are the same and each of the personal profiles is unique.

### BRIEF DESCRIPTION OF THE DRAWINGS

FIG. 1 is a block diagram showing some of the components typically incorporated in at least some of the computer systems and other devices on which the facility operates.

FIG. 2 is a data flow diagram showing the operation the facility according to some embodiments.

FIG. 3 is a block diagram showing a user profile.

FIG. 4 is a flow chart of the establishment of a user profile according to some embodiments.

FIG. 5 is a flow chart of the generation of a heuristic list according to some embodiments.

FIG. 6 is an example of a heuristic list according to some embodiments.

FIG. 7 is a flow chart of the preparing of a deployment sequence according to some embodiments.

FIG. 8 is an example of a deployment sequence according to some embodiments.

FIG. 9 is an execution timeline of a deployment sequence according to some embodiments.

FIG. 10 is a flow chart of the verification of an established user profile according to some embodiments.

FIG. 11 a data flow diagram showing the operation the facility according to some embodiments.

### DETAILED DESCRIPTION

Establishing a user profile on a computer system often includes setting a plurality of permissions, configuring a plurality of system parameters, creating a plurality of data storage containers, and installing a plurality of application binaries.

The inventors have recognized that conventional approaches for establishing a user profile on a computer system consume computational resources, for example, CPU time, network bandwidth, or memory space.

The inventors have also recognized that mobile devices have significantly less computational resources than personal computers (PCs) or servers. The inventors have further recognized that mobile devices have significantly more permission options than PCs or servers, for example, permissions to operate sensors or cameras.

In response to recognizing these disadvantages, the inventors have conceived and reduced to practice a software and/or hardware facility for efficiently establishing user profiles on mobile devices. (“the facility”).

In some embodiments, the facility at least partially operates on a deployment server. An administrator enters a plurality of inputs to the deployment server. The deployment server generates a heuristic list based on the inputs. The heuristic list, for example, may include a plurality of system parameters, a plurality of permissions, and a plurality of applications. The deployment server may query a mobile device for capability information. The capability information, for example, may include an operating system (OS) version, a device model, a CPU model, and an amount of available memory. The deployment server prepares a deployment sequence for example, a sequential order of commands to execute, a list of folders to be created, or a list of applications to be installed to establish a user profile, in a way that is sensitive to the capability information. The deployment server executes the deployment sequence and causes the mobile device to invoke a series of commands. For example, the deployment server may download a binary of an application to a local hard drive. The deployment server may push the binary to the mobile device. The deployment server may cause the mobile device to invoke a command in parallel with or in sequence to the binary push.

In some embodiments, the deployment server executes a plurality of tests to verify the established user profiles. A test, for example, may include the deployment server causing the mobile device to execute a command, and checking a behavior of the mobile device upon execution of the command. For example, the test includes a command to access a folder which is not accessible by a user profile. The deployment server verifies that the command fails for lack of permissions. In some embodiments, the deployment server may save a whole or a part of the deployment sequence in its data storage, for example, a hard drive. In some embodiments, the deployment server may execute the deployment sequence, causing a plurality of mobile devices to execute a same set of commands. The plurality of mobile devices being a same or similar model to the mobile device. For example, a corporation issues a standard work phone to all its employees. The corporation establishes on each of its standard work phones a work profile and a personal profile. The work profile may include necessary corporate applications, such as email or security verifier. The work profile may include credentials to access corporate data. The personal profile may include unprivileged access to data storage and include utility applications such as calculators. An administrator prepares a deployment sequence for one work phone and execute it for all work phones.

By performing in some or all of the ways described above, the facility facilitates establishment of multiple user profiles on different mobile devices. The facility reduces the workload of administrators by allowing them to create one deployment sequence from a set of inputs, and executing that deployment sequence on multiple mobile devices, instead of repeating the set of inputs on every mobile device. The facility also reduces the chance of human error while establishing multiple user profiles. Repeated inputs of a similar kind are prone to error. By saving the deployment sequence and verifying the established user profiles, the facility may avoid human error caused by administrators while establishing multiple user profiles on multiple devices. Businesses adopting the facility may reduce cost in administrators and avoid consequential lost due to human error in the establishment of user profiles.

Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, the facility may save network transmission bandwidth by first downloading binaries to its local storage, instead of having each mobile device downloaded its applications. The facility also saves scarce mobile device computation resources by pushing those binaries, instead of the mobile devices searching and downloading on their own. The facility further reduces computation on mobile devices by having most of the computation done on a deployment server.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc.

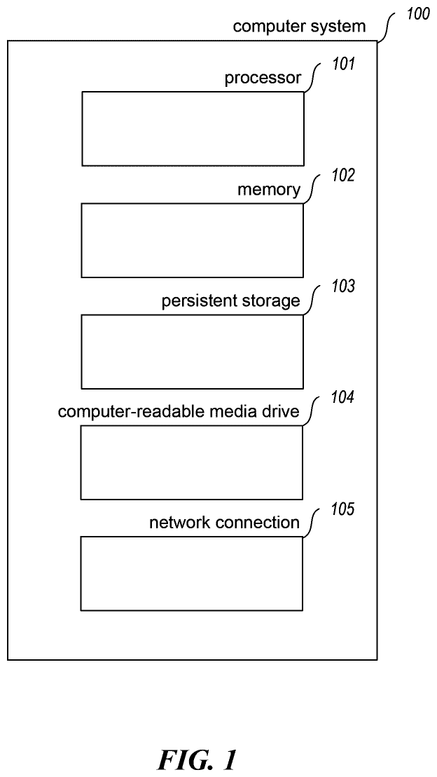

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102—such as RAM, SDRAM, ROM, PROM, etc.—for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 1 and discussed above constitutes a data signal per se. While computer systems configured as described above are typically used to support the operation of the facility, those skilled in the art will appreciate that the facility may be implemented using devices of various types and configurations, and having various components.

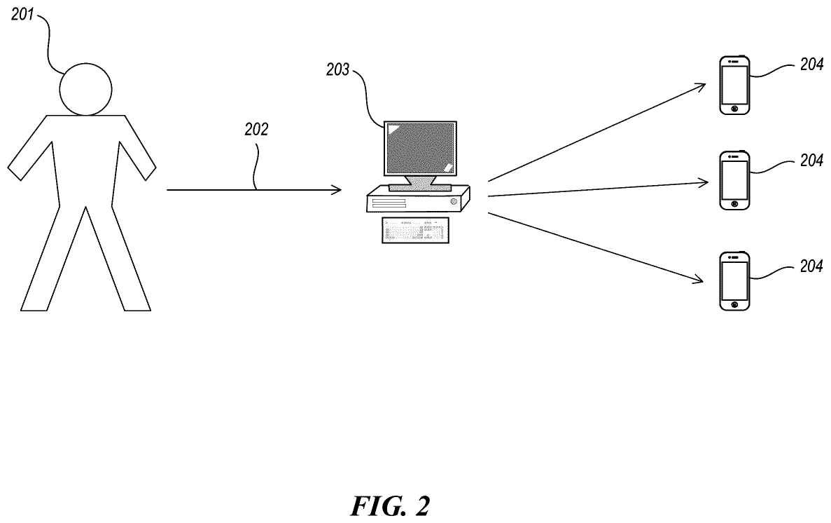

FIG. 2 is a data flow diagram showing the operation the facility according to some embodiments. An administrator 201 operates a deployment server 203. The deployment server 203 is a computer system, for example, a personal computer. The facility operates at least partially on the deployment server 203. The administrator 201 makes a plurality of inputs 202 to the deployment server 203. The deployment server 203 receives those inputs 202 and establishes user profiles on mobile devices 204. There may be a plurality of mobile devices 204 connected to the deployment server 203.

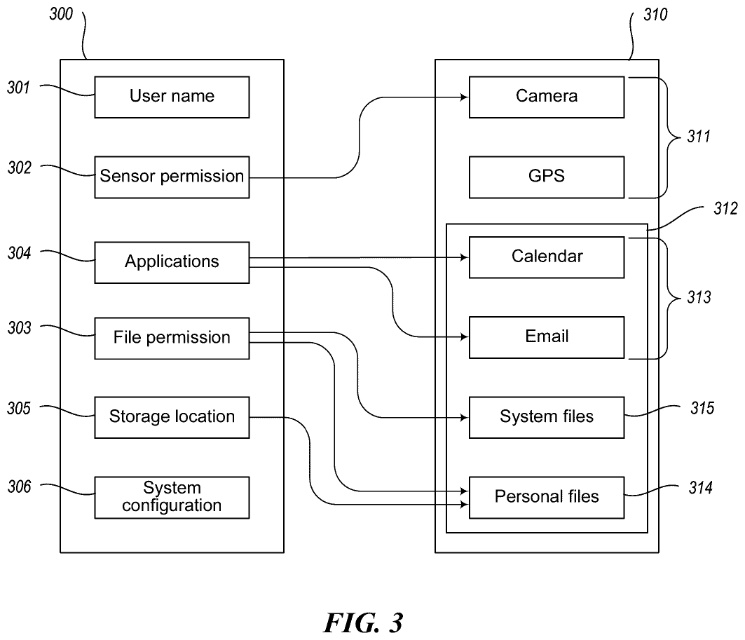

FIG. 3 is a block diagram showing a user profile. A user profile 300 contains a plurality of parameters. These parameters in user profile 300 corresponds to data on mobile device 310. For example, user profile 300 contains a username 301, a plurality of sensor permissions 302, a plurality of file permissions 303, an application list 304, and a plurality of storage locations 305, and a plurality of system configurations 306. The sensor permissions 302 may include permissions to operate a camera, and a GPS. The sensor permissions 302 corresponds to the sensors 311 available on the mobile device 310. The available sensors and associated permissions vary depending on available mobile device hardware. File permissions 303 corresponds to file storage 312 on the mobile device 310, and may include permissions to access personal files 314 and deny access to system files 315. Application list 304 is a list of applications 313 that will be installed on mobile device 310 under the user profile 300. Applications 304. For example, application list 304 may include calendar and email applications 313. Storage locations 305 includes locations on file storage 312 that will be created for the user profile 300, for example, personal files 314. System configurations 306 includes settings for mobile device 310, for example, permissions to connect to a virtual private network (VPN), or permissions to connect to a network carrier.

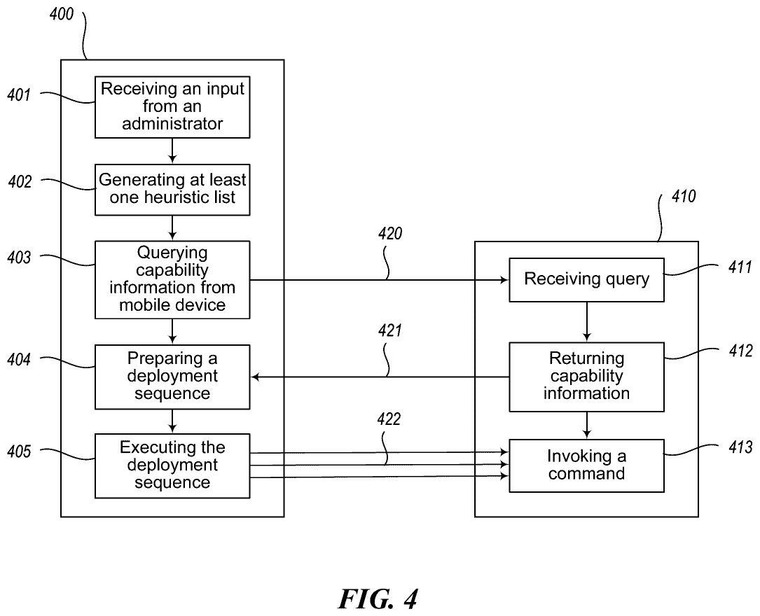

FIG. 4 is a flow chart of the establishment of a user profile according to some embodiments. In a deployment server 400, at a step 401, the deployment server receives an input from an administrator to establish a user profile. The input contains a username, a list of applications, and a list of permissions. At a step 402, the deployment server prepares a heuristic list from the input. At a step 403, the deployment server 400 sends a query 420 to a mobile device 410 for its capabilities information. In the mobile device 410, at a step 411, the mobile device receives query 420. At a step 412, the mobile device generates a capability information 421 and returns it to deployment server 400. At a step 404, the deployment server prepares a deployment sequence. The deployment sequence includes commands 422 to invoke on the mobile device 410 and the order and timing to invoke those commands. At a step 405, the deployment server 400 executes the deployment sequence, causing the mobile device 410 to invoke commands 422.

Those skilled in the art will appreciate that the acts shown in FIG. 4, and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

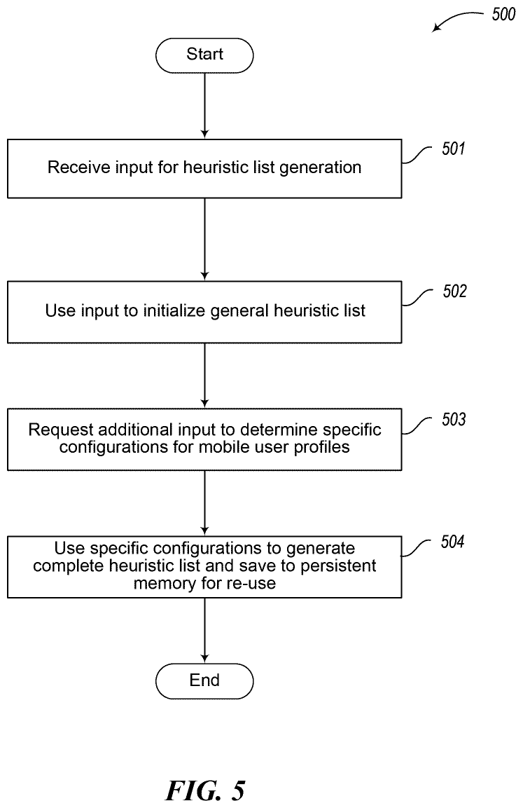

FIG. 5 is a flow chart of the generation of a heuristic list according to some embodiments. In some examples, the inputs received by the facility in 501 for generation of the heuristic list are commands or files supplied directly to the facility for processing into one or more heuristic lists used for the instantiation and configuration of one or more mobile user profiles. In various examples, the inputs received by the facility in 501 for generation of the heuristic list are pre-existing inputs associated with a pre-existing heuristic list. In some examples, the inputs received by the facility in 501 for heuristic generation are generalized descriptions of the application in which the mobile device will be deployed. For example, corporate standard configurations and government or military standard configurations.

A general heuristic list is generated in 502 for base configurations applied to mobile user profiles based on the input received in 501. This general heuristic list is not sufficient for complete instantiation and configuration of mobile device user profiles. The general heuristic list contains basic configuration information including but not limited to: the number of user profiles to create, the base system configurations, the permissions associated with each user profile, and the applications to load into each mobile user profile. After producing the general heuristic list, the facility requests additional information in 503 for more specific configurations to be applied to each mobile user profile. This additional information can include but is not limited to: sensor permissions, hardware specific values, resources, or requirements, policy specific configuration requirements including but not limited to: regulatory, government, military, etc.

In 504, the specific configurations from 503 are then synthesized and combined with the general heuristic list from 501 to produce a complete heuristic list with all required components for automated configuration and instantiation of one or more mobile user profiles. The complete heuristic list is then saved to persistent memory on the current device for re-use or modification as needed.

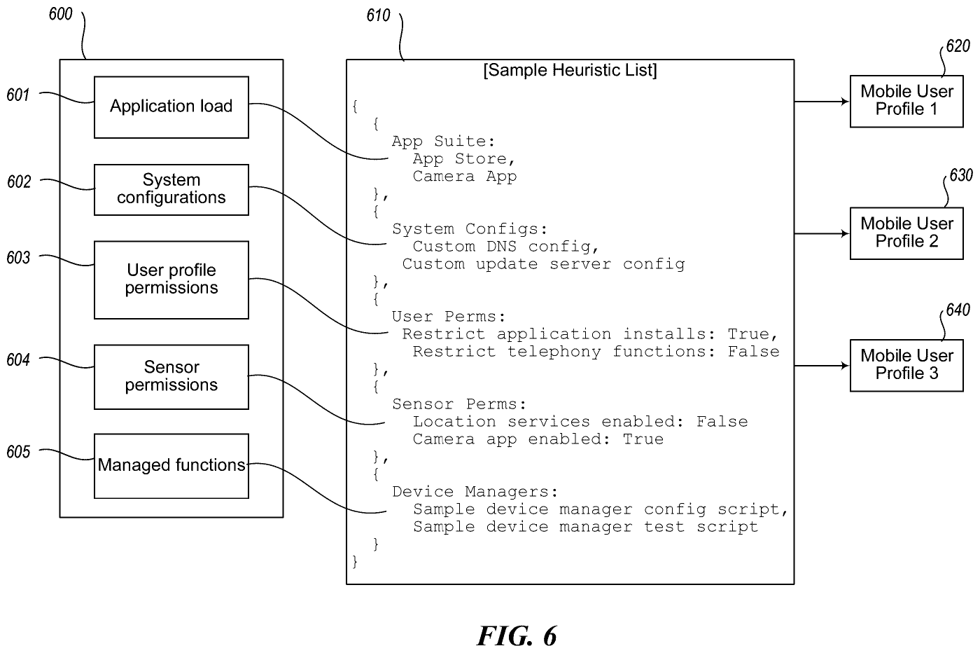

FIG. 6 is an example of a heuristic list according to some embodiments. A heuristic list 600 may be represented as a JSON object 610 in text form. Heuristic list 600 includes application load 601, system configurations 602, user profile permissions 603, sensor permissions 604, and managed functions 605. Heuristic list 600 may establish a plurality of user profiles for a plurality of mobile devices. For example, Heuristic list 600 is used to establish user profiles 620, 630, 640. Application load 601 includes a list of applications to be installed, for example, an App store and a Camera App. System configurations 602 includes device settings, for example, DNS customization, VPN configuration, carrier selection, and update server location. User profile permissions 603 include permissions to access files storage and application on a mobile device, for example, a user may have access to run an application but not have access to install or remove the application. A user may receive telephone calls but not initiate telephone calls. Sensor permissions 604 includes permissions to access hardware or software sensors on a mobile device. For example, a user may have access to a camera but not GPS. Managed functions 605 includes scripts and software that may be installed on a mobile device to facilitate operation of the facility on the mobile device. The heuristic list 600 may be saved at a storage on the deployment server for future use.

While FIG. 6 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc. Additionally, in some embodiments, rather than storing the data shown in the table diagrams in tables, the facility stores it in semi-structured or unstructured data stores, such as JSON objects.

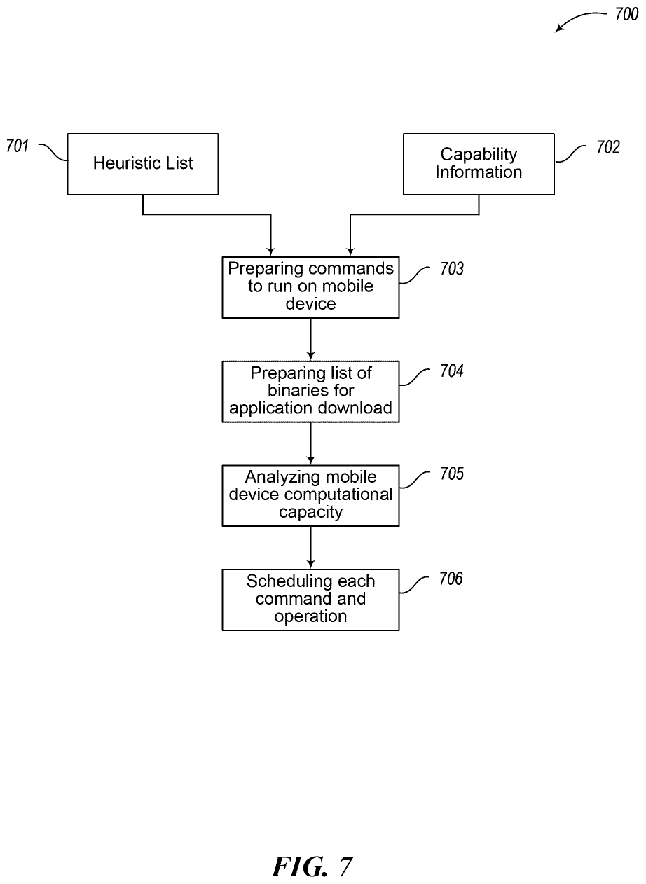

FIG. 7 is a flow chart of the preparing of a deployment sequence according to some embodiments. At a step 703, a deployment server prepares a plurality of commands that will be invoked on a mobile device. The commands are, in some cases, specific to the model of the mobile device. The deployment server takes a heuristic list 701 and a capacity information 702 as input. Heuristic list 701 is prepared as previously described and may be in JSON format. Capacity information 702 includes details of the mobile device, for example, a model name or number, an OS version identifier, available system memory, available storage, and a list of available sensors. At a step 704, the deployment server prepares a plurality of applications to be installed. In some embodiments, the deployment server prepares the applications by first downloading their binaries from a remote location, for example, an app store, to a storage location, for example, a hard drive. Having the binaries first downloaded and stored locally saves time and computational resources during installation on the mobile device. At a step 705, the deployment server analyzes the computational capacity of the mobile device using the capacity information 702. The deployment server determines a preferred number of concurrent commands the mobile device will run. In some embodiments, the deployment server determines a maximum number of concurrent operations that the mobile device can execute. At a step 706, the deployment server determines an order of which those commands run. In some embodiments, the deployment server schedules the commands such that a total execution time of those commands is under a configurable limit. For example, the deployment server may push binaries of an application to the mobile device concurrently with the mobile device invoking commands to set permissions for camera and GPS, but after the mobile device had run a command to create a local personal file storage location for a user profile.

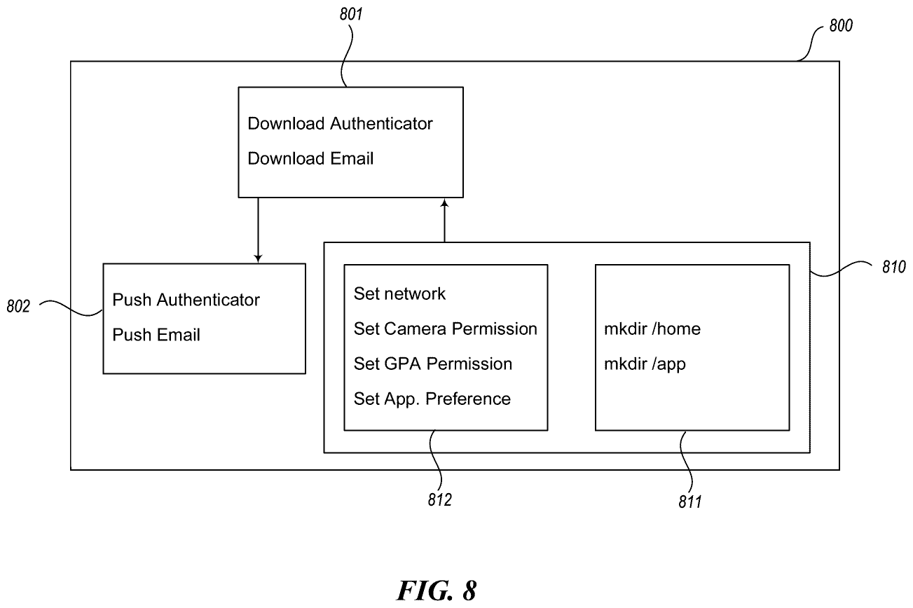

FIG. 8 is an example of a deployment sequence according to some embodiments. Deployment sequence 800 includes a download section 801, where a deployment server downloads application binaries, for example, of an authenticator and an email application. After download section 801, deployment sequence 800 includes binary push section 802 and mobile device command invocation section 810. Binary push section 802 and mobile device command invocation section 810 may be executed in sequence or in parallel. In binary push section 802, the deployment server pushes the binaries of applications to a mobile device, for example, the binaries of the authenticator application and the email application. Commands in mobile device command invocation section 810 are invoked by the mobile device. These commands are further grouped into configuration commands 812 and storage location commands 811. Configuration commands 812 configures system and user setting parameters, for example, preferred network carrier, permission to access a camera, permission to access GPS, or application specific preferences. Storage location commands 811 includes commands to create storage locations in a file system on the mobile device related to a user profile, for example, a user home folder or a user application folder. The deployment sequence 800 may be saved to a storage location on the deployment server for future use.

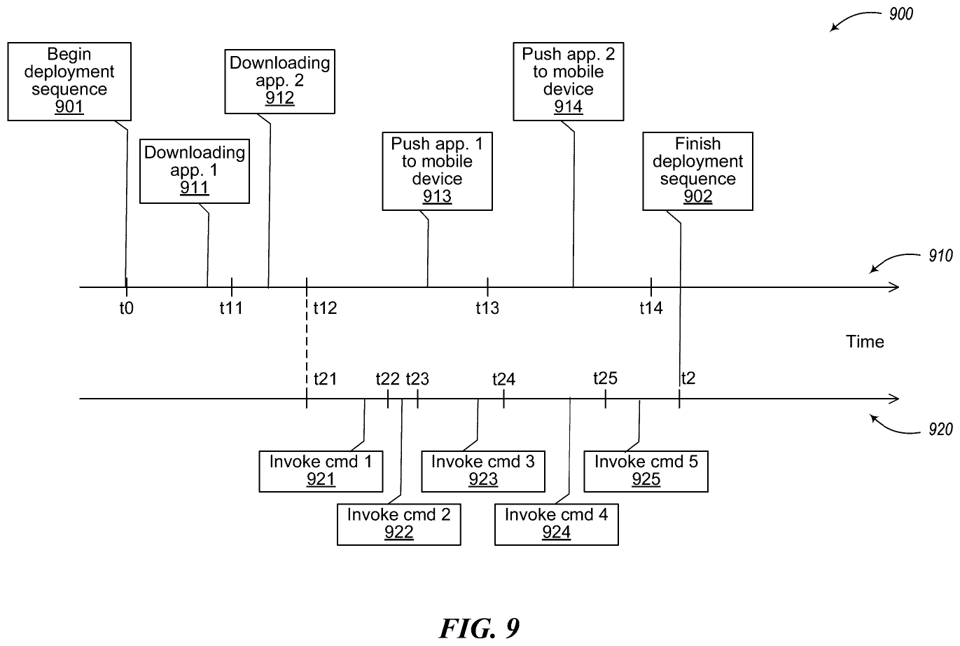

FIG. 9 is an execution timeline of a deployment sequence according to some embodiments. Timeline 910 shows operations on a deployment server and timeline 920 shows operation on a mobile device connected to the deployment server. At time t0, the deployment server begins a deployment sequence 901. According to the deployment sequence, the deployment server first downloads application 1. 911. At time t11 application 1 is downloaded and the deployment server downloads application 2 912. At time t12 application 2 is downloaded and the deployment server begins to push binaries of application 1 to the mobile device 913. At time t21, which is contemporaneous to time t12, the deployment server causes the mobile device to invoke a command cmd1 921 in parallel to the push of application 1 913. The mobile device invokes command cmd1 921. At time t22, the deployment server has not finished pushing application 1 913, but the mobile device has finished invoking cmd1 921. The deployment server causes the mobile device to invoke another command cmd2 922. The mobile device invokes command cmd2 922. At time t23, the deployment server has still not finished pushing application 1 913, but the mobile device has finished invoking cmd2 922. The deployment server causes the mobile device to invoke another command cmd3 923. The mobile device invokes command cmd3 923. At time t13, push of application 1 913 has completed and the mobile device has not finished invoking cmd3 923. The deployment server begins to push binaries of application 2 to the mobile device 914. At time t24, the mobile device finished invoking cmd3 923. The deployment server causes the mobile device to invoke another command cmd4 924, in parallel to the push of application 2 914. The mobile device invokes command cmd4 924. At time t25, the deployment server has not finished pushing application 2 914, but the mobile device has finished invoking cmd4 924. The deployment server causes the mobile device to invoke another command cmd5 925. The mobile device invokes command cmd5 925. At time t14, the push of application 2 914 completes and the mobile device has not completed invoking command cmd5 925. The deployment server waits. At time t2, the mobile device completes invoking command cmd5 925. The deployment sequence is finished 902.

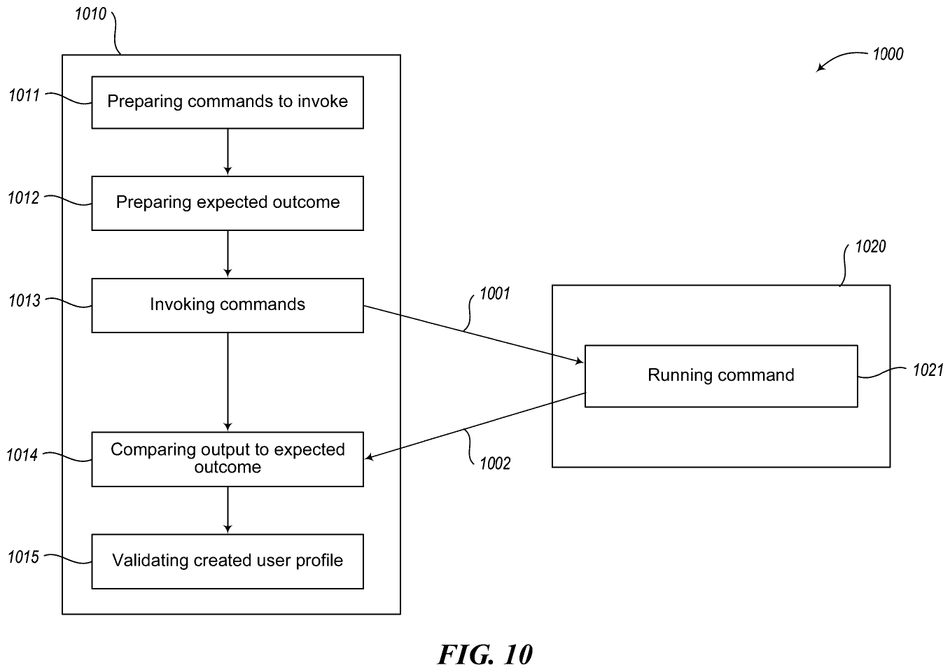

FIG. 10 is a flow chart of the verification of an established user profile according to some embodiments. In a deployment server 1010, at a step 1011, the deployment server prepares a command 1001 to invoke on a mobile device 1020. At a step 1012, the deployment server prepares an expected outcome of when the mobile device 1020 invokes the command 1001. At a step 1013, the deployment server 1010 causes the mobile device 1020 to invoke the command 1001. At a step 1021, the mobile device invokes the command 1001 and produces an output 1002. The output 1002 is returned to the deployment server 1010. At a step 1014, the deployment server receives the output 1002 and compares it to the expected outcome. At a step 1015, the deployment server validates a created user profile if the received output 1002 is consistent with the expected outcome, or if the received output 1002 is inconsistent with the expected outcome, invalidates the created user profile.

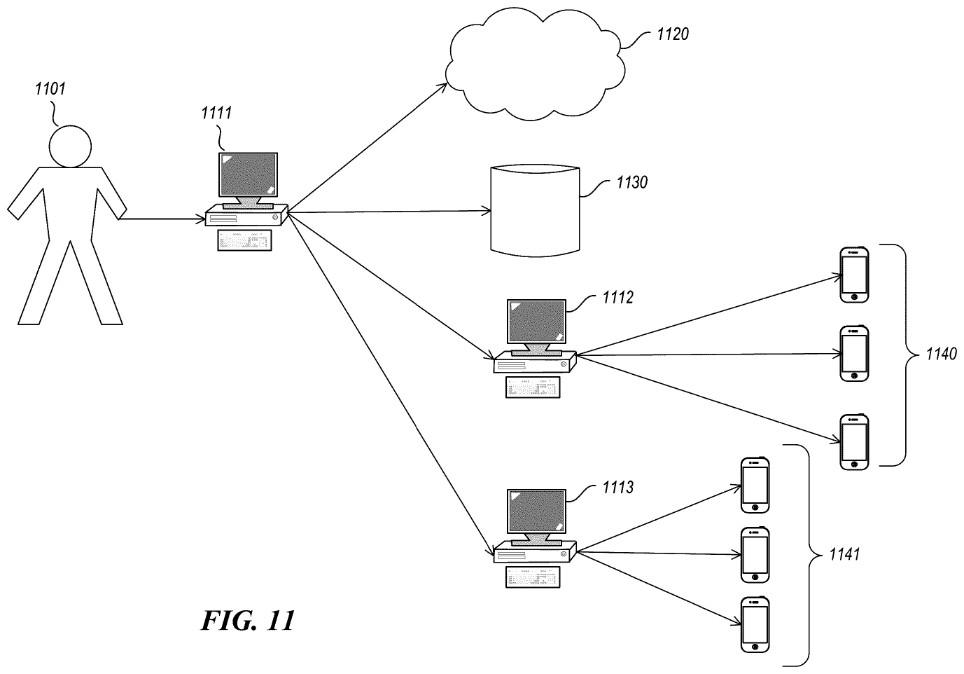

FIG. 11 a data flow diagram showing the operation the facility according to some embodiments. An administrator 1101 operates a terminal 1111. The terminal is connected to a plurality of computer systems, including a cloud computing service 1120, a storage device 1130, or other remote computers 1112 1113. The terminal 1111, cloud computing service 1120, storage device 1130, and other remote computers 1112 1113 forms a deployment server where the facility operates. Mobile devices may connect with the deployment servers by a plurality of endpoints at a plurality of locations. Some mobile devices 1140 connects to the deployment server by the computer 1112. Some mobile devices 1141 connect to the deployment server by another computer 1113. In some embodiments, a deployment sequence is generated on the terminal 1111 and saved at the storage device 1130. The remote computers 1112 1113 may retrieve the saved deployment sequence from the storage device 1130 and execute it. In some embodiments, a deployment sequence is generated on a first computer 1112, executed for a first plurality of mobile devices 1140 and saved. The deployment sequence is retrieved at a different time by a different computer 1113 and executed for a second plurality of mobile devices 1141.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method establishing a user profile on a mobile device, comprising:
in a deployment server different from the mobile device,
receiving an input from an administrator;
generating at least one heuristic list from the input;
querying capability information from the mobile device;
preparing a deployment sequence from the heuristic list and the capability information, the deployment sequence comprising at least one command;
executing the deployment sequence; and
causing the mobile device to invoke commands in an order according to the deployment sequence.

2. The method of claim 1, further comprising:
in the deployment server,
preparing a test sequence, the test sequence comprising at least one command;
causing the mobile device to invoke a command from the test sequence; and
verifying an output of the mobile device after invoking the command from the test sequence.

3. The method of claim 2, further comprising:
saving the test sequence to a storage device;
causing a second mobile device to invoke a command from the test sequence; and
verifying a second output of the second mobile device after invoking the command from the test sequence.

4. The method of claim 1, further comprising:
in the deployment server,
saving the deployment sequence to a storage device; and
causing a second mobile device to invoke commands in an order according to the deployment sequence.

5. The method of claim 1, wherein preparing a deployment sequence comprises:
preparing at least one command to run on the mobile device; and
preparing at least one application to download.

6. The method of claim 5, wherein executing the deployment sequence comprises:
downloading a binary representation of the at least one application from a remote server to a local storage; and
pushing the downloaded binary to the mobile device.

7. The method of claim 6, wherein pushing the downloaded binary is performed simultaneously with causing the mobile device to invoke commands.

8. The method of claim 7, wherein the capacity information includes at least one from the following group: a model name or number, an OS version identifier, an amount available system memory, an amount of available storage, and a list of available sensors.

9. The method of claim 8, wherein preparing a deployment sequence from the heuristic list and the capability information comprises:
analyzing a computational capacity of the mobile device using the capacity information; and
scheduling the at least one command to run on the mobile device.

10. The method of claim 1, wherein the deployment sequence includes at least one command to set a permission to a sensor.

11. A system, comprising:
at least one deployment server, and
a mobile device, wherein the at least one deployment server is configured to perform the following:
receiving an input from an administrator;
generating at least one heuristic list from the input;
querying capability information from the mobile device;
preparing a deployment sequence from the heuristic list and the capability information; and
causing the mobile device to invoke commands in an order according to the deployment sequence.

12. The system of claim 11, further comprising:
a second mobile device, wherein the at least one deployment server comprises:
a storage device, wherein the at least one deployment server is further configured to perform the following:
saving the deployment sequence to the storage device; and
causing the second mobile device to invoke commands in an order according to the deployment sequence.

13. The system of claim 12, wherein the at least one deployment server comprises a first computer and a second computer, the first computer connected to the mobile device and the second computer connected to the second mobile device.

14. The system of claim 11, wherein the at least one deployment server is further configured to perform the following:
preparing a test sequence, the test sequence comprising at least one command;
causing the mobile device to invoke a command from the test sequence; and
verifying an output of the mobile device after invoking the command from the test sequence.

15. The system of claim 14, wherein the at least one deployment server is further configured to perform the following:
saving the test sequence to a storage device;
causing a second mobile device to invoke a command from the test sequence; and
verifying a second output of the second mobile device after invoking the command from the test sequence.

16. The system of claim 15, wherein the at least one deployment server comprises a first computer and a second computer, the first computer connected to the mobile device and the second computer connected to the second mobile device.

17. A computer-readable medium including contents that are configured to cause a computing system to establish a user profile on a mobile device by performing a method comprising:
receiving an input from an operator;
generating at least one heuristic list from the input;
querying capability information from the mobile device;
preparing a deployment sequence from the heuristic list and the capability information;
executing the deployment sequence; and
causing the mobile device to invoke command in an order according to the deployment sequence.

18. The computer-readable medium of claim 17, wherein the method further comprises:
preparing a test sequence, the test sequence comprising at least one command;
causing the mobile device to invoke a command from the test sequence; and
verifying an output of the mobile device after invoking the command from the test sequence.

19. The computer-readable medium of claim 18, wherein the method further comprises:
saving the test sequence to a storage device;
causing a second mobile device to invoke a command from the test sequence; and
verifying a second output of the second mobile device after invoking the command from the test sequence.

20. The computer-readable medium of claim 17, wherein the method further comprises:
saving the deployment sequence to a storage device; and
causing a second mobile device to invoke commands in an order according to the deployment sequence.
